(19) United States
(12) Patent Application Publication
(10) Pub. No.: US 2006/0008259 A1
(43) Pub. Date: Jan. 12, 2006

(54) DVD recorder to be connected to IEEE 1394 serial bus

(75) Inventor: Jyunya Senoo, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/176,336

(22) Filed: Jul. 8, 2005

(30) Foreign Application Priority Data
Jul. 8, 2004 (JP) 2004-201710

(51) Int. Cl. H04N 5/781

(52) U.S. Cl. 386/125; 386/126

(57) ABSTRACT

A DVD recorder to be connected to an IEEE1394 serial bus, which includes position specifying means for specifying the position of data of unnecessary part in the stream data received from the DV camcorder, storage means for storing information of the position of data of the unnecessary part specified by a user using the position specifying means, and a microprocessor that controls writing of the stream data such that the data of the unnecessary part is not written on the DVD but only data of a necessary part out of the stream data received from the DV camcorder is written on the DVD) based on the information of the position of data of the unnecessary part, which has been read out from the storage means.

### BACKGROUND OF THE INVENTION

1. Field of the Invention

The present invention relates to a DVD (Digital Versatile Disc) recorder that can be connected to a digital video camera recorder (hereinafter abbreviated as a DV camcorder) via an IEEE1394 serial bus.

2. Description of the Related Art

Conventionally, in dubbing recorded data from a DV (Digital Video) tape to a DVD by connecting a DV camcorder and a DVD recorder via an IEEE1394 serial bus, a user has dubbed the recorded data of the entire tape or performed an operation to temporarily stop dubbing manually when the data reached the position of an unnecessary part during dubbing even if the tape included an unnecessary part for the user. However, when the user dubs the recorded data of the entire DV tape on the DVD, all data including data of an unnecessary part are written on the DVD. Further, if the user takes a method to temporarily stop dubbing manually when the data reached the position of the unnecessary part in recorder data during dubbing, it is often the case that data of a necessary part cannot be written on the DVD or data of the unnecessary part is written on the DVD. Besides, once the user fails to record only the data of the necessary part, the user needs to perform an operation of rewinding both the DV tape and the DVD and restart recording after adjusting the reproducing position of the DV tape and the recording position of the DVD together, which takes a lot of trouble. Therefore, the user seldom reattempts recording practically.

### SUMMARY OF THE INVENTION

The present invention has been created to solve the above-described objects, and it is an object of the invention to provide a DVD recorder to be connected to an IEEE1394 serial bus, which is capable of writing only data of a necessary part from among stream data received from the DV camcorder on a DVD by a simple operation.

To achieve the above-described objects, the invention according to the aspect of Claim 1 includes an IEEE1394 interface circuit, which is connected to a DV camcorder and a display device via the IEEE1394 serial bus and used for transmitting/receiving control commands and their reply signals, and for transmitting/receiving stream data to/from the DV camcorder, an optical pickup for writing the stream data received from the DV camcorder via the IEEE1394 interface circuit on a DVD, position specifying means for specifying the position of data of an unnecessary part in the stream data received from the DV camcorder, storage means for storing information of the position of data of the unnecessary part specified by a user by asking the position specifying means, and a microprocessor that controls writing of the stream data such that the data of the unnecessary part is not written on the DVD but only data of a necessary part out of the stream data received from the DV camcorder is written on the DVD based on the information of the position of data of the unnecessary part, which has been read out from the storage means.

In the above-described constitution, the user displays the content of the stream data received from the DV camcorder on a display device connected to the DVD recorder, specifies the position of the data of the unnecessary part in the stream data received from the DV camcorder by using the position specifying means while checking the displayed content, and thus it is possible to prevent the data of the unnecessary part in the stream data from being written on the DVD in writing the stream data received from the DV camcorder on the DVD. Namely, only data of a necessary part out of the stream data received from the DV camcorder can be written on the DVD by a simple operation. Further, even in the case where timing of specifying the position of the data of the unnecessary part using the above-described position specifying means is off, the user performs an operation for rewinding only to a DV tape, displays the content of the stream data received from the DV camcorder on a monitor again, specifies the position of the data of the unnecessary part using a position specifying key while checking the displayed content, and thus he/she can accurately re-specify the position of the data of the unnecessary part. Therefore, even in this case, only data of the unnecessary part out of the stream data received from the DV camcorder can be cut by a simple operation.

Preferably, said storage means stores the starting position and the ending position of data of an unnecessary part specified by a user using said position specifying means.

Said microprocessor, in writing the stream data received from said DV camcorder on the DVD by said optical pickup, starts writing the stream data received from said DV camcorder on the DVD by said optical pickup after reading out the starting position and the ending position of the data of the unnecessary part from said storage means.

Said microprocessor stops writing said stream data on the DVD when the position of the stream data received from said DV camcorder becomes equal to the starting position of the data of said unnecessary part.

Said microprocessor restarts writing said stream data on the DVD when the position of the stream data received from said DV camcorder becomes equal to the ending position of the data of said unnecessary part.

The starting position and the ending position of the data of said unnecessary part are stored in said storage means in a time code format.

Preferably, said microprocessor displays a message prompting the connection of an IEEE1394 serial bus cable on said display device when said microprocessor detects that said DVD recorder is not connected to said DV camcorder via said IEEE1394 serial bus cable.

Said microprocessor executes transmission processing of a rewind command and a reproduction command to said DV camcorder and processing of writing the stream data received from said DV camcorder on the DVD by said optical pickup after said microprocessor detects that said DVD recorder has been connected to said DV camcorder via said IEEE1394 serial bus cable.

It is possible that said DVD recorder further comprises a display section for displaying various messages or the like, and said microprocessor displays a message prompting the connection of an IEEE1394 serial bus cable on said display section when said microprocessor detects that said DVD recorder is not connected to said DV camcorder via said IEEE1394 serial bus cable.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an electrical block diagram of a DVD recorder according to the first embodiment of the present invention and a DV camcorder connected to the DVD recorder.

FIG. 2 is a flowchart of cut processing of data of an unnecessary part in the DVD recorder.

FIG. 3A is an explanation drawing of the problem of a conventional DVD recorder.

FIG. 3B is another explanation drawing of the problem of a conventional DVD recorder.

FIG. 3C is an explanation drawing of the effect of the cut processing shown in FIG. 2.

FIG. 4 is a flowchart of process in the case where an IEEE1394 serial bus cable to be connected to a DVD recorder according to the second embodiment of the present invention is unfastened.

FIG. 5 is a perspective view showing the connection between the DVD recorder, the DV camcorder and a DTV.

### DESCRIPTION OF THE PREFERRED EMBODIMENTS

Best modes for implementing the present invention will be described with reference to the drawings. The present invention relates to a DVD recorder that can be connected to a DV camcorder via an IEEE1394 serial bus. In the following embodiments, description will be made for an example where the present invention has been applied to a DVD) recorder capable of reading/writing a DVD (Digital Versatile Disc)-RAM (Random Access Memory). Note that the embodiments described below do not fully cover the present invention, and the present invention is not limited to the modes below.

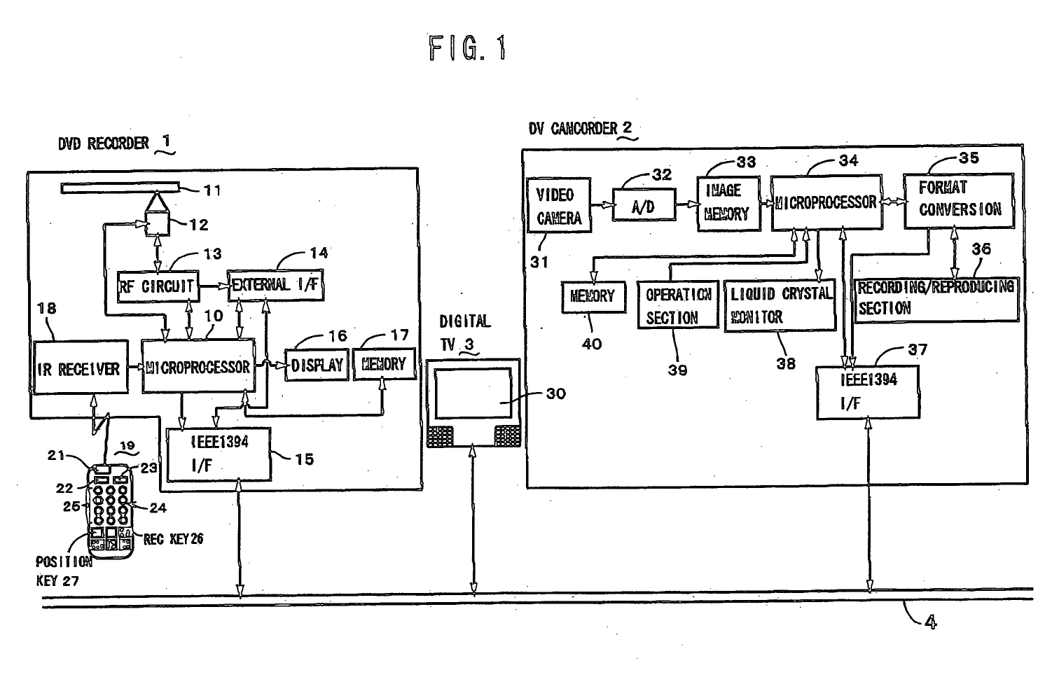

FIG. 1 is the electrical block diagram of the DVD recorder according to the first embodiment and the DV camcorder that can be connected to the DVD recorder via the IEEE1394 serial bus. The DVD recorder 1 is connected to a DV camcorder 2 and a digital television receiver 3 (hereinafter, referred to as a digital TV) via an IEEE1394 serial bus 4 (hereinafter, abbreviated as a bus). The DVD recorder 1 is capable of writing stream data received from the DV camcorder 2 on a DVD-RAM 11 and can display the stream data received from the DV camcorder 2 on a monitor 30 by outputting the data to the digital TV 3. The DVD recorder 1 includes a microprocessor 10 for controlling each section of the device. Further, the DVD recorder 1 has an optical pickup 12 that radiates optical beam to the DVD-RAM 11 to record and reproduce data, an RF circuit 13 that processes RF signals output from the optical pickup 12, an external interface 14 (hereinafter, referred to as an external I/F) that performs data format conversion or the like when data is input/output from/to an external input/output device, an IEEE1394 interface 15 (hereinafter, referred to as an IEEE1394 I/F), a display section (display) 16 for displaying various messages, and a memory 17 (storage means) for storing data such as time codes of a starting position and an ending position of data of an unnecessary part specified by the user using a remote controller 19. The IEEE1394 I/F 15 is for transmitting/receiving controlling commands and their reply signals, and for transmitting/receiving stream data to/from the external input/output equipment via the bus 4. Furthermore, the DVD recorder 1 has an infrared ray signal receiver (IR receiver) 18 for receiving infrared signals transmitted from the remote controller 19.

The above-described remote controller 19 has a key section 24 that consists of various keys and an infrared signal transmitting section 21. On the key section 24, a menu key 22 for displaying various menus is disposed in addition to a power key 23 and keys 25 for inputting numbers. Further, on the key section 24, a recording key (REC key) 26 to command to write the stream data from connected equipment for data input (DV camcorder 2 in the case of the constitution shown in FIG. 1) on the DVD-RAM 11, a position specifying key (position key) 27 (position specifying means) to specie the starting position and the ending position of the data of the unnecessary part in the received stream data, and the like are arranged.

Furthermore, the DV camcorder 2 includes an IEEE1394 interface 37 (hereinafter, referred to as an IEEE1394 I/F) for receiving data such as controlling commands from the DVD recorder 1 or the like via the bus 4, a video camera 31 that outputs a subject image, which has been photographed by a built-in CCD (Charge Coupled Device), in the form of analog signals, an A/D conversion section 32 that converts the analog signals output from the video camera 31 into digital signals, an image memory 33 that temporarily accumulates image data sent from the A/D conversion section 32, a microprocessor 34 that applies various image processing to the image data accumulated in the image memory 33, a format conversion circuit 35, and a recording/reproducing section 36. The format conversion circuit 35 performs format conversion to the stream data of image data to which processing by the microprocessor 34 has been done. The recording/reproducing section 36 performs writing of the stream data output from the format conversion circuit 35 on a DV (Digital Video) tape, reproducing the stream data recorded on the DV tape, or the like. Further, the DV camcorder 2 includes a liquid crystal monitor 38 that displays images sent from the microprocessor 34, an operation section 39, and a memory 40 for storing various data.

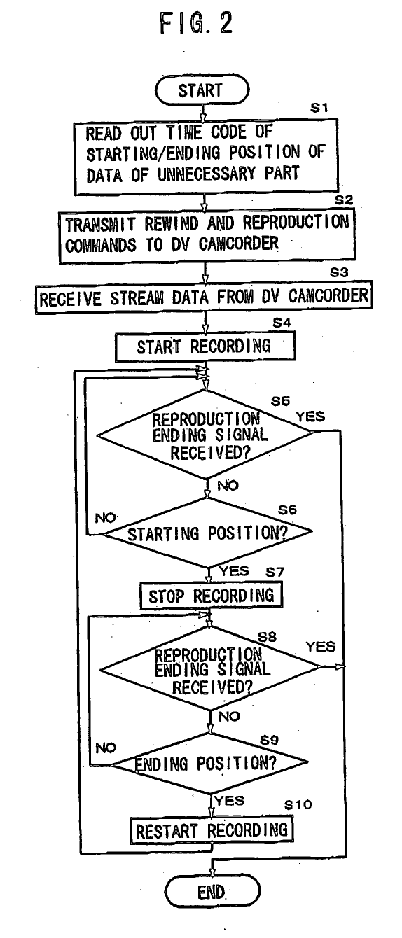

Next, description will be made for the cut processing of the data of the unnecessary part in the DVD recorder 1 with reference to FIG. 2. Firstly the user, by using the remote controller 19, instructs outputting of the stream data received from the DV camcorder 2 to the digital TV 3 after performing an instruction operation of reproduction start to the DV camcorder 2. With the above-described method, the user checks the content of the stream data that the DVD recorder 1 has received from the DV camcorder 2 on the monitor 30. Then, when the user specifies the starting position and the ending position of the data of the unnecessary part in the stream data received from the DV camcorder 2 by using the position specifying key 27 of the remote controller 19, the microprocessor 10 obtains the time codes of the starting position and the ending position of the data of the unnecessary part from the stream data, and stores them in the memory 17. Next, when the user presses the recording key 26 of the remote controller 19 to instruct writing of the stream data from the DV camcorder 2 on the DVD-RAM 11, the microprocessor 10 transmits a rewind command and a reproduction command to the DV camcorder 2 (S2) after reading out tie time codes of the starting position and the ending position of the data of the unnecessary part from the memory 17 (S1), starts receiving the stream data from the DV camcorder 2 (S3), and starts writing the received stream data on the DVD-RAM 11 (S4).

When the above-described writing processing starts, the microprocessor 10 detects whether or not a time code, which is included in the stream data received from the DV camcorder 2, has become equal to the time code of the starting position of the data of the unnecessary part (S6) until it receives a reproduction ending signal from the DV camcorder 2 (NO at S5). As a result, when the time codes become equal (YES at S6), the microprocessor 10 stops writing on the DVD-RAM 1 by the optical pickup 12 (stops recording) (S7). Then, the microprocessor 10 detects whether or not the time code, which is included in the stream data received from the DV camcorder 2, has become equal to the time code of the ending position of the data of the unnecessary part (S9) until it receives the reproduction ending signal from the DV camcorder 2 (NO at S8), and restarts writing (restarts recording) on the DVD-RAM 11 by the optical pickup 12 (S10) when the time codes become equal (YES at S9). The microprocessor 10 repeats the processing of S5 to S10 until it receives the reproduction ending signal from the DV camcorder 2 (NO at S5 or NO at S8).

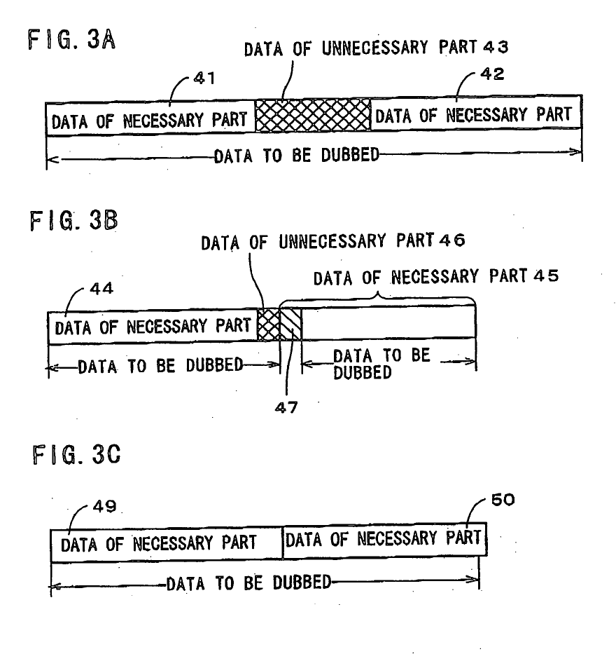

Next, description will be made for the effect of the cut processing of the data of the unnecessary part with reference to FIGS. 3A, 3B and 3C. Conventionally, in dubbing recorded data from the DV tape to the DVD-RAM, the user dubbed the recorded data of the entire tape in the DVD-RAM or performed an operation to temporarily stop dubbing manually when the data reached the position of an unnecessary part during dubbing even if the tape included an unnecessary part for the user. However, when the user dubs the recorded data of the entire DV tape on the DVD-RAM, not only data 41, 42 of necessary pails but also data 43 of an unnecessary part are written on the DVD-RAM as shown in FIG. 3A. Further, if the user takes a method to temporarily stop dubbing manually when the recorded data reached the position of the unnecessary part during dubbing, it is often the case that a piece of data 47 in data 45 of the necessary part cannot be written on the DVD-RAM or data 46 of the unnecessary part is written on the DVD-RAM as shown in FIG. 3B. Besides, once the user fails to record only the data of the necessary part, the user needs to perform an operation of rewinding both the DV tape and the DVD-RAM and restart recording after adjusting the reproducing position of the DV tape and the recording position of the DVD-RAM together, which takes a lot of trouble. Therefore, the user seldom reattempted recording practically.

On the other band, when the user takes the method of cut processing shown in FIG. 2, even if the timing of specifying the starting position and the ending position using the above-described position specifying key 27 is off, the user performs a rewinding operation only to the DV tape, displays the content of the stream data received from the DV camcorder 2 on the monitor 30 again, specifies the starting position and the ending position of the data of the unnecessary part by using the position specifying key 27 while checking the displayed content, and thus can accurately re-specify the positions. Therefore, even in such a case, only data of the unnecessary part in the stream data received from the DV camcorder 2 is cut accurately, and only data 49, 50 of the necessary part in the stream data received from the DV camcorder 2 can be written on the DVD-RAM 11 with a simple operation.

As described above, according to the DVD recorder 1 of the first embodiment, it is possible that the data of the unnecessary part in the stream data received from the DV camcorder 2 is not written on the DVD-RAM 11 but only the data of the necessary part in the stream data received from the DV camcorder 2 is written on the DVD-RAM 11.

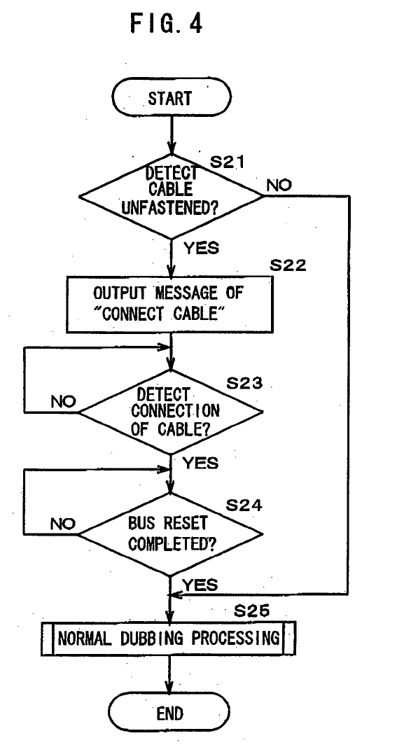

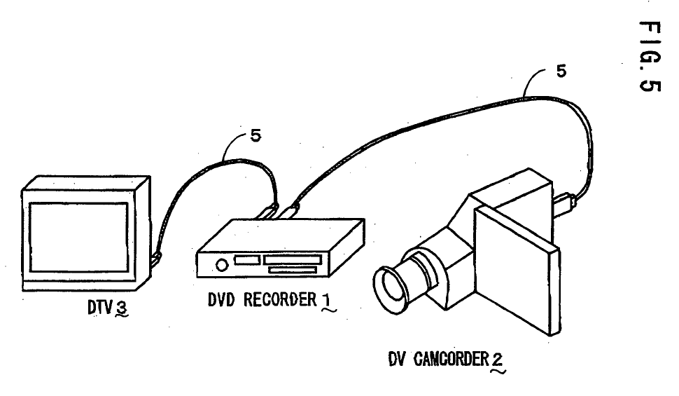

Next, description will be made for the cut processing of the data of the unnecessary part in the case where the IEEE1394 serial bus cable to be connected to the DVD recorder 1 according to the second embodiment is unfastened with reference to the flowchart shown in FIG. 4. Note that the DVD recorder 1 of the second embodiment has the same electrical blocks as the electrical blocks of the first embodiment shown in FIG. 1. The second embodiment is an embodiment corresponding to Claims 4, 5 and 7. When the microprocessor 10 detects that an IEEE1394 serial bus cable 5 (refer to FIG. 5) to the DV camcorder 2 is not connected (YES at S21), it displays a message saying “Connect cable” on the monitor 30 (S22) to prompt the user to connect the IEEE1394 serial bus cable 5.

Then, when the microprocessor 10 detects the connection of the IEEE1394 serial bus cable 5 (YES at S23), it performs the same processing as normal dubbing processing (S25) shown in FIG. 2 after detecting that bus reset has been completed (YES at S24). Specifically, the microprocessor 10 transmits the rewind command to the DV camcorder 2, transmits the reproduction command to the DV camcorder 2 after receiving the rewind completion signal from the DV camcorder 2, cuts only data of the unnecessary part in the stream data received from the DV camcorder 2, and writes data other than the unnecessary data on the DVD-RAM 11. With this method, even when the IEEE1394 serial bus cable 5 to the DV camcorder 2 is unfastened while the stream data received from the DV camcorder 2 is written on the DVD-RAM 11, only data of the unnecessary part in the stream data received from the DV camcorder 2 is cut, and only data of the necessary part in the stream data received from the DV camcorder 2 can be written on the DVD-RAM 11 with a simple operation.

The message saying “Connect cable” may be displayed on the display section 16 built into the DVD recorder 1 instead of displaying it on the monitor 30. The DVD recorder 1 adopting such processing is the invention corresponding to Claim 8.

Note that the present invention is not limited to the above-described embodiments, but various modifications can be made. For example, the starting position and the ending position of the data of the unnecessary part in the stream data received from the DV camcorder 2 were specified by using the position specifying key 27 of the remote controller 19 in the first embodiment, but a method of setting the position of data of the unnecessary part is not limited to this. For example, the position of the data of the unnecessary part may be set by using a menu key and an enter key of the remote controller.

This application is based on Japanese patent application 2004-201710 filed Jul. 8, 2004, the contents of which are hereby incorporated by reference.

What is claimed is:

1. A DVD recorder to be connected to an IEEE1394 serial bus, comprising:
an IEEE1394 interface circuit, which is connected to a DV camcorder and a display device via the IEEE1394 serial bus and used for transmitting/receiving control commands and reply signals thereof, and for transmitting/receiving stream data to/from said DV camcorder;
an optical pickup for writing the stream data received from said DV camcorder via said IEEE1394 interface circuit on a DVD;
position specifying means for specifying the position of data of an unnecessary part in the stream data received from said DV camcorder;
storage means for storing information of the position of data of the unnecessary part specified by a user using said position specifying means; and
a microprocessor that controls writing of the stream data such that the data of said unnecessary part is not written on the DVD but only data of a necessary part out of the stream data received from said DV camcorder is written on the DVD based on the information of the position of data of the unnecessary part, which has been read out from said storage means.

2. The DVD recorder to be connected to an IEEE1394 serial bus according to claim 1,
wherein said storage means stores the starting position and the ending position of data of an unnecessary part specified by a user using said position specifying means;
wherein said microprocessor, in writing the stream data received from said DV camcorder on the DVD by said optical pickup, starts writing the stream data received from said DV camcorder on the DVD by said optical pickup after reading out the starting position and the ending position of the data of the unnecessary part from said storage means;
wherein said microprocessor stops writing said stream data on the DVD when the position of the stream data received from said DV camcorder becomes equal to the starting position of the data of said unnecessary part; and
wherein said microprocessor restarts writing said stream data on the DVD when the position of the stream data received from said DV camcorder becomes equal to the ending position of the data of said unnecessary part.

3. The DVD recorder to be connected to an IEEE1394 serial bus according to claim 2, wherein said storage means stores the starting position and the ending position of the data of said unnecessary part in a time code format.

4. The DVD recorder to be connected to an IEEE1394 serial bus according to claim 3,
wherein said microprocessor displays a message prompting the connection of an IEEE1394 serial bus cable on said display device when said microprocessor detects that said DVD recorder is not connected to said DV camcorder via said IEEE1394 serial bus cable; and
wherein said microprocessor executes transmission processing of a rewind command and a reproduction command to said DV camcorder and processing of writing the stream data received from said DV camcorder on the DVD by said optical pickup after said microprocessor detects that said DVD) recorder has been connected to said DV camcorder via said IEEE1394 serial bus cable.

5. The DVD recorder to be connected to an IEEE1394 serial bus according to claim 2,
wherein said microprocessor displays a message prompting the connection of an IEEE1394 serial bus cable on said display device when said microprocessor detects that said DVD recorder is not connected to said DV camcorder via said IEEE1394 serial bus cable; and
wherein said microprocessor executes transmission processing of a rewind command and a reproduction command to said DV camcorder and processing of writing the stream data received from said DV camcorder on the DVD by said optical pickup after said microprocessor detects that said DVD recorder has been connected to said DV camcorder via said IEEE1394 serial bus cable.

6. The DVD recorder to be connected to an IEEE1394 serial bus according to claim 5, wherein said storage means stores the starting position and the ending position of the data of aid unnecessary part in a time code format.

7. The DVD recorder to be connected to an IEEE1394 serial bus according to claim 1,
wherein said microprocessor displays a message prompting the connection of an IEEE1394 serial bus cable on said display device when said microprocessor detects that said DVD recorder is not connected to said DV camcorder via said IEEE1394 serial bus cable; and
wherein said microprocessor executes transmission processing of a rewind command and a reproduction command to said DV camcorder and processing of writing the stream data received from said DV camcorder on the DVD by said optical pickup after said microprocessor detects that said DVD recorder has been connected to said DV camcorder via said IEEE1394 serial bus cable.

8. The DVD recorder to be connected to an IEEE1394 serial bus according to claim 1,
wherein said DVD recorder further comprises a display section for displaying various messages or the like;
wherein said microprocessor displays a message prompting the connection of an IEEE1394 serial bus cable on said display section when said microprocessor detects that said DVD recorder is not connected to said DV camcorder via said IEEE1394 serial bus cable; and
wherein said microprocessor executes transmission processing of a rewind command and a reproduction command to said DV camcorder and processing of writing the stream data received from said DV camcorder on the DVD by said optical pickup after said microprocessor detects that said DVD recorder has been connected to said DV camcorder via said IEEE1394 serial bus cable.
